(19) United States
(12) Patent Application Publication
(10) Pub. No.: US 2006/0127097 A1
(43) Pub. Date: Jun. 15, 2006

(54) Utilizing a laser to securely communicate with radio frequency identification tags

(75) Inventors: Andrei Obrea, Seymour, CT (US); Thomas J. Foth, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/011,982

(22) Filed: Dec. 14, 2004

(51) Int. Cl. H04B 10/00

(52) U.S. Cl. 398/115

(57) ABSTRACT

A method for providing a secure communications channel for the transmission of large amounts of information between a RFID tag and a RFID reader. A laser beam is utilized to carry information and power from the RFID reader to the RFID tag. Thus, the laser beam has a dual use as an information carrier and a source of power for the RFID tag. Thus, only individuals and/or equipment that can both see the laser transmission and hear the RFID transmission can eavesdrop on the RFID tag RFID reader transmissions. This invention allows the use of complex algorithms to protect data being communicated because they can use the increased level of power available to the RDIF tag.

### FIELD OF THE INVENTION

This invention relates to electronic systems and, more particularly, to securely communicating with a radio frequency identification device that does not use batteries.

### BACKGROUND OF THE INVENTION

Radio frequency identification device (RFID) tags have been programmed to contain digital information either during the manufacturing of the read-only memory portion of the RFID integrated circuit, or in the field using electromagnetic radio frequency signals to store information in the nonvolatile memory portion of the RFID tag.

A RFID tag does not require contact or line-of-sight to operate. RFID tags can function under a variety of environmental conditions and provide a high level of data integrity. RFID tags utilize radio frequency signals to transfer information from the RFID tag to a RFID reader and from the RFID reader to the RFID tag. Thus, radio waves are used to transfer information between the RFID tag and the RFID reader from the RFID reader to the RFID tag. A disadvantage of the foregoing is that the information transmitted by the RFID tag may be intercepted easily and read by an unintended party.

One method utilized by the prior art to protect transmitted information between a RFID tag and a RFID reader was to encrypt the transmitted information.

The packaging for RFID tags must be inexpensive, small and light. The least expensive RFID tags do not use batteries. Such RFID tags have electronic circuits that are powered by converting the energy of RF fields created by the RFID reader and captured by the RFID tag's antenna. As a result, the amount of electronic circuitry available in RFID tags powered only by the energy of RF fields is severely limited. Furthermore, the complexity of algorithms to process data and the amount of data stored in such circuits are also very limited. Currently, RFID tags use simple algorithms to protect the information exchanged with the RFID reader. The best RFID tags can do is to store a small amount of private information (e.g., their identity numbers or any secret information used to protect the communication with the RFID reader). Thus, one of the disadvantages of the prior art is that RDIF tag circuits do not protect private information against sophisticated attackers. Such attackers can obtain secret information stored in RFID tags using inexpensive equipment.

Another disadvantage of the foregoing is that the amount of energy obtained by the RFID tags only from RF fields created by RFID readers is not sufficient to compute and analyze messages protected by strong cryptographic algorithms.

RFID tags using batteries are more expensive, bigger and have a limited life. In addition to that, they may be less reliable as the battery may exhaust its energy during operation.

### SUMMARY OF THE INVENTION

This invention overcomes the disadvantages of the prior art by providing a secure communications channel for the transmission of a large amount of information between a RFID tag and a RFID reader. A laser beam is utilized to carry information and power from the RFID reader to the RFID tag. Thus, the laser beam has a dual use as an information carrier and a source of power for the RFID tag. Thus, only individuals and/or equipment that can both see the laser transmission and hear the RFID transmission can eavesdrop on the RFID tag RFID reader transmissions. This invention allows the use of complex algorithms to protect data being communicated, because they can use the increased level of power available to the RDIF tag. Additionally, more data can be stored in the tag. Additionally, using more sophisticated packaging can enhance the physical protection of stored data.

This invention accomplishes the foregoing by generating a light beam that carries power and information to a radio frequency identification device, and receiving a radio frequency signal from the radio frequency identification device in response to the information carried by the light beam.

An advantage of this invention is that the RFID tag does not require a battery since it receives power from a laser beam.

### BRIEF DESCRIPTION OF THE DRAWINGS

FIG. 1 is a block diagram showing communications between a RFID tag and a RFID reader;

FIG. 2 is a drawing showing the elements of FIG. 1 in greater detail; and

FIG. 3 is a flow chart of the operation of digital signal processor 80 of FIG. 2.

### DETAILED DESCRIPTION OF THE PREFERRED EMBODIMENT

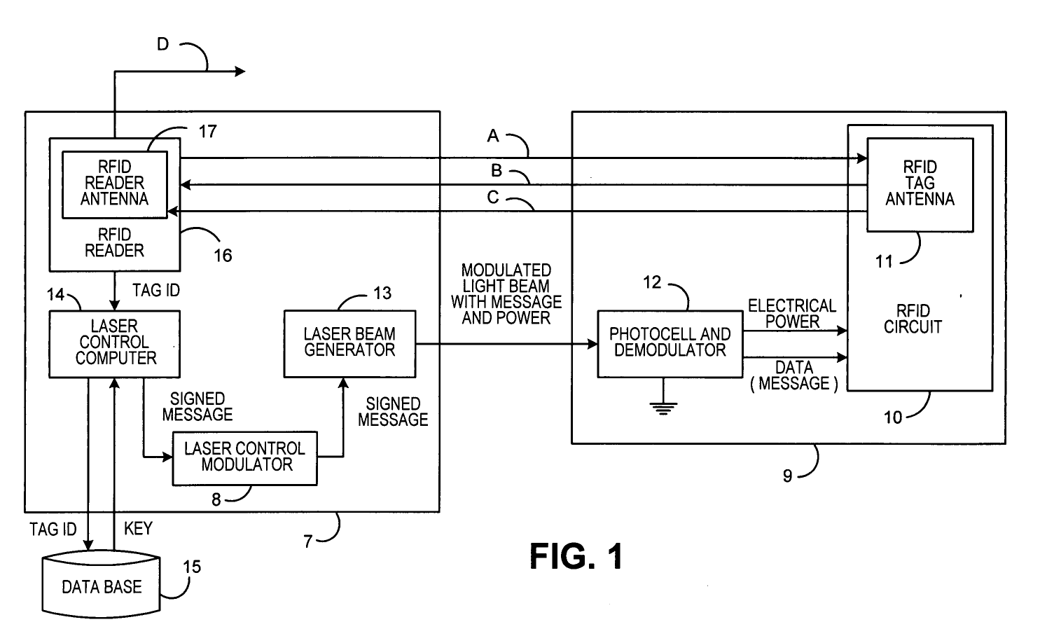

Referring now to the drawings in detail, and more particularly to FIG. 1, the reference character 9 represents a RFID tag. Tag 9 includes RFID circuit 10, which has a RFID tag antenna 11 attached thereto. RFID circuit 10 is coupled to photocell and demodulator 12. Demodulator and photocell 12 receives a light beam from laser beam generator 13. Generator 13 is coupled to modulator 8 and modulator 8 is coupled to laser control computer 14. Laser control computer 14 is coupled to data base 15 and computer 14 is also coupled to RFID reader 16, which has a RFID reader antenna 17 attached thereto. Computer 14, modulator 8 and generator 13 may be part of a bar code reader connected to the RFID reader 16. Computer 14, modulator 8, generator 13, reader 16 and antenna 17 comprise base station 7. Communications between RFID circuit 10 and RFID reader 16 would be performed as follows.

RFID reader 16 will cause RFID antenna 17 to transmit a radio frequency (RF) request signal via channel A that would be received by RFID tag antenna 11. The aforementioned RF signal will request RFID circuit 10 to transmit its tag identification to RFID reader 16. After antenna 11 receives the RF request signal, RFID circuit 10 will process the signal and transmit via antenna 11 and channel B a RF signal containing the tag identification of RFID circuit 10. Antenna 17 will receive the signal containing the tag identification of RFID circuit 10. RFID reader 16 will process and/or authenticate the signal containing the tag identification and transmit the tag identification of RFID circuit 10 to laser control computer 14. Computer 14 will transmit the tag identification of RFID circuit 10 to database 15. Database 15 will read its database to determine the cryptographic key for the tag identification of RFID circuit 10. Database 15 will transmit the determined cryptographic key to computer 14. Computer 14 will incorporate the cryptographic key into a message that becomes a signed message requesting tag 10 to transmit the protected information contained in circuit 10 to reader 16. Computer 14 will transmit the signed message to modulator 8. Modulator 8 will transmit the signed message to laser beam generator 13. Generator 13 will process the signed message and produce a modulated laser light beam output that has the signed message and the power of the light beam. Photocell and demodulator 12 will receive the signed message and power. When photocell and demodulator 12 is illuminated by the laser power, the photocell will convert the laser power into electricity and the demodulator will demodulate the signed message. The electrical power will be transmitted to circuit 10 via a power channel and the signed message will be transmitted to circuit 10 via a data channel. Circuit 10 will transmit protected payload information stored in tag 10 via antenna 11, channel C, and antenna 17 to RFID reader 16. Protected payload information may be anything written into RFID tag 10, i.e., the contents of a container; the identity of the owner of the container; instructions for transporting the goods contained in the container; the name of the owner of the goods in the container; the value of the goods contained in the container; information regarding previous processing steps for the goods contained in the container; biometric information contained in a passport; biometric information contained in a identification card; information contained in a smart card; a persons medical records; answers to questions contained in a mail piece; financial information contained in a mail piece, etc. The aforementioned payload information is transmitted from RFID reader 16 via channel D to other devices (not shown), i.e., a computer that uses the protected payload information the intended application.

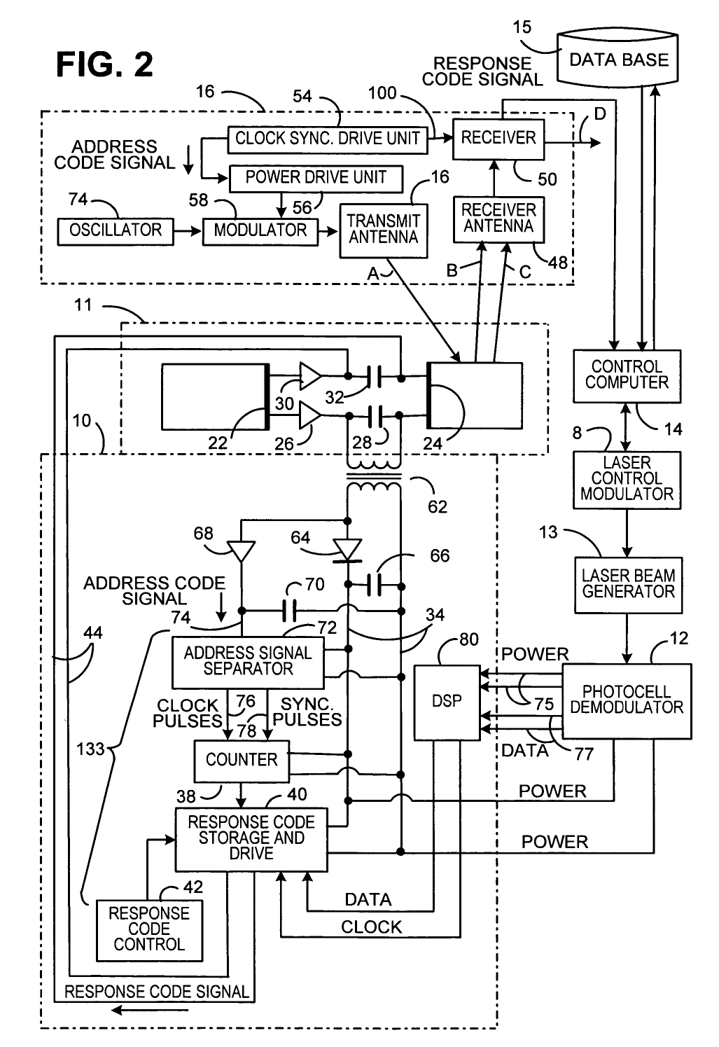

FIG. 2 is a drawing showing the elements of FIG. 1 in greater detail. Antenna 11 includes feed terminals 22 and 24, diodes 26, and 30 and capacitors 28 and 32. The low voltage or primary terminals of transformer 62 are connected across bypass capacitor 28. Transformer 62 is tuned to resonate at the frequency of the power signal and is also matched to the load and operates to produce a higher voltage signal of this frequency at its output terminals. In other words, the carrier or radio frequency signals are bypassed by capacitor 28 whereas the envelope of the pulses, which occur at the modulation frequency, are applied to the tuned transformer. Effectively, therefore, the sidebands of the illuminating signal are used to obtain the power signal to energize information circuit 133 during the initial identity inquiry, i.e., to supply the power to a subset of the circuitry of circuit 10 sufficient to receive the request transmitted via channel A and to retrieve the tag ID from RFID circuit 10 and transmitted back via channel B to RFID reader 16.

A series chain comprising a power signal detector 64 and a filter capacitor 66 is connected across the secondary terminals of transformer 62. The capacitance of this filter capacitor 66 must be sufficiently high as to store voltage throughout the clock and sync pulses included in the address code signal and to power the digital information circuit 133. A second series chain comprising an address code detector 68 and a bypass capacitor 70 is connected across the output terminals of the transformer 62. The capacitance of this bypass capacitor 70 must be sufficiently low as to transmit without significant distortion the clock and sync pulses included in the address code signal and must be sufficiently high as to store voltage throughout the period of the power signal.

The digital information circuit 133 comprises a series chain comprising an address signal separator 72, counter 38, and response code storage and drive 40 and response code control 42. Leads 34 are connected between filter capacitor 66 and the power input terminals of signal separator 72, counter 38, and response code storage and drive 40. A lead 74 is connected from the junction of the address code detector 68 and the bypass capacitor 70 to the address signal separator 72. Lead 74 applies the address code signal comprising clock and sync pulses to the address signal separator 72. The address signal separator 72 is a pulse width discriminator that operates to separate the clock and sync pulses from the transmitted signal train. These separated signals are individually applied as pulses to the counter 38. A response code control 42 may be connected to the response code storage and drive 40 to alter the number, duration, spacing, and modulation frequency of the pulses comprising the response code signal. The response code control 42 may be operated by manual switches or by a sensor. The response code signal produced by information circuit 133 is applied across the bypass capacitor 32 via leads 44. Thus, information circuit 133 provides the identity of tag 9.

Power is transmitted from photocell and demodulator 12 to digital signal processor (DSP) 80 via lines 75 and data is transmitted from photocell and demodulator 12 to DSP 80 via lines 77. Photocell and demodulator 12 is also coupled to leads 34 to supply power to response code storage and drive 40. DSP 80 used the data carried by the light beam from generator 13 to authenticate the request for information, retrieve the information requested and send the information to response code storage and drive 40. DSP 80 also transmits data and clock pulses to response code storage and drive 40 and antenna 11. At this time antenna 11, which is powered from photocell and demodulator 12 will communicate with RFID reader 16 using channel C.

The request to transmit the tag ID from RFID circuit 10 is initiated by RFID reader 16, which includes series chain comprising a clock-sync drive unit 54, a power drive unit 56, and a modulator 58 that is connected between the oscillator 74 and antenna 48. Antenna 48 transmits a RF Request Signal via channel A that is received by feed 24 of antenna 11. The aforementioned signal request RFID circuit 10 to transmit its tag identification to RFID reader 16. Receiver 50 and receiver antenna 17 are components of reader 16. Clock-synchronization drive unit 54 produces an address code signal comprising a synchronizing pulse followed by clock pulses. A lead 100 connects drive unit 54 to receiver 50. This address code signal is employed to control the information received from digital information circuit 133 included in RFID circuit 10. Power drive unit 56 produces a power signal that is higher in frequency than the frequency of the address code signal. The clock-sync drive unit 54 operates to turn off the power drive unit 56 during the time of occurrence of the clock and synchronizing pulses. Accordingly, an address coded power signal is applied to modulator 58, which operates to modulate the frequency produced by oscillator 74 with this address coded power signal. Receiver 50 is coupled to RFID reader antenna 17 and drive unit 54, receiver 50 produces a response code information signal or protected payload signal that is transmitted via channel D.

The information containing the identity of RFID tag 10 is transmitted via channel B and is used by laser control unit 14 to retrieve the private information, i.e., cryptographic keys from database 15 to be subsequently used for the creation of the message to be transmitted via channel C. After the message to be transmitted on channel C was created in laser control computer 14, it is used to modulate the laser beam produced by generator 13 under the control of modulator 8.

After RFID reader 16 processes the signal containing the tag identification, receiver 50 of reader 16 will transmit the tag identification of RFID circuit 10 to laser control computer 14. Computer 14 will transmit the tag identification of RFID circuit 10 to database 15. Database 15 will read its database to determine the cryptographic key for the tag identification of RFID circuit 10. Database 15 will transmit the determined cryptographic key to computer 14. Computer 14 will incorporate the cryptographic key into a message that becomes a signed message requesting tag 10 to transmit the protected information contained in circuit 10 to reader 16. Computer 14 will transmit the signed message to laser control modulator 8. Modulator 8 will transmit the signed message to laser beam generator 13. Generator 13 will process the signed message and produce a modulated laser light beam output that has the signed message and the power of the light beam. Photocell and demodulator 12 will receive the signed message and power. When photocell and demodulator 12 is illuminated by the laser power, the photocell will convert the laser power into electricity and the demodulator will demodulate the continuous signed message. It would be obvious to one skilled in the art that other (less secure) methods of authenticating a message could be used instead of digital signatures (e.g., agreed upon algorithms, numeric transformations, etc.) The electrical power will be transmitted to DSP 80 via lines 75 and the signed message will be transmitted to DSP 80 via lines 77. Circuit 10 will transmit payload information stored in information circuit 133 via feed 24 of antenna 11, channel C, and antenna 17 to RFID reader 16.

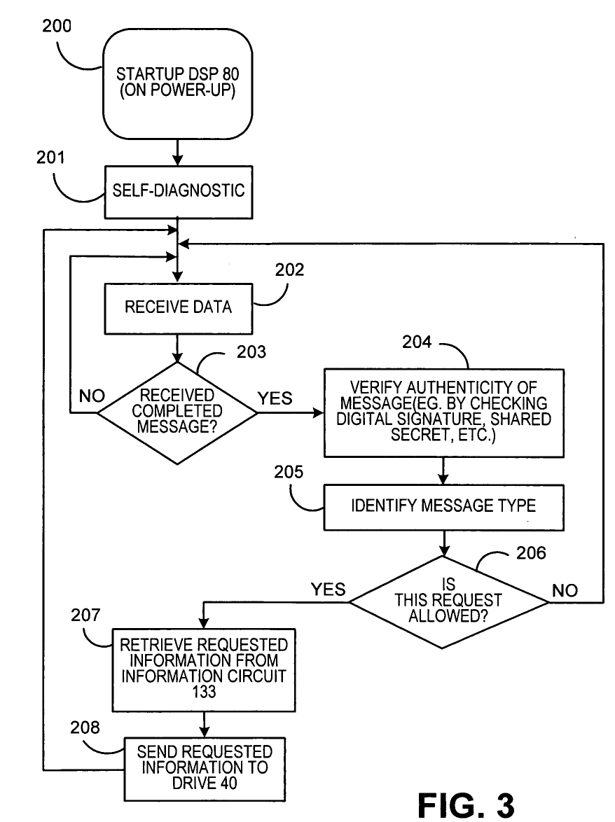

FIG. 3 is a flow chart of the operation of digital signal processor 80 of FIG. 2. The program begins in block 200, when power is supplied to DSP 80 (FIG. 2). Then the program goes to block 201 where DSP 80 performs self-diagnostic tests. Now the program goes to block 202 where DSP 80 receives data from photocell demodulator 12. Now the program goes to decision block 203. Decision block 202 determines whether or not the data DSP 80 received from photocell demodulator 12 formed a complete message. If block 203 determines that DSP 80 did not receive a complete message the program goes back to the input of block 203. If block 203 determines that DSP 80 received a complete message the program goes to block 204. Block 204 verifies the authenticity of the message, by verifying the digital signature of the message. Then the program goes to block 205 to identify message type. At this point the program goes to decision block 206. Decision block 206 determines whether or not the request in the message is allowed. If block 206 determines that the request is not allowed the program goes back to the input of block 202. If block 206 determines that the request is allowed the program goes to the input of block 207. Block 207 retrieves the requested information from the internal storage of the DSP 80. Now the program goes to block 208 and sends the information to drive 40. Then the program goes back to the input of block 202 to wait for incoming data.

The above specification describes a new and improved method for securely communicating with a RFID device. It is realized that the above description may indicate to those skilled in the art additional ways in which the principles of this invention may be used without departing from the spirit. Therefore, it is intended that this invention be limited only by the scope of the appended claims.

What is claimed is:

1. A method for securely communicating between a radio frequency identification device and a reader, which comprises the steps of:
A) generating a light beam that carries power and information to the radio frequency identification device, and
B) receiving a radio frequency signal from the radio frequency identification device in response to the information carried by the light beam.

2. The method claimed in claim 1, wherein in step A, a laser beam transmits the information securely.

3. The method claimed in claim 2, wherein the laser beam transmits secure information using digital cryptographic methods.

4. The method claimed in claim 1, further including the step of requesting the identity of the radio frequency identification device by transmitting radio frequency signals from the reader to the radio frequency identification device.

5. The method claimed in claim 4, further including the step of:
transmitting by the radio frequency identification device to the reader the information identifying the radio frequency identification device.

6. The method claimed in claim 5, further including the step of:
receiving by the reader the information identifying the radio frequency identification device.

7. The method claimed in claim 6, further includes the step of:
retrieving from a database information which is specific to the device identified by the identifying information received from the radio frequency identification device.

8. The method claimed in claim 1, further including the step of:
transmitting protected payload information stored in the radio frequency identification device to the reader.

9. The method claimed in claim 8, wherein the payload information is information written into the radio frequency identification device.

10. The method claimed in claim 8, wherein the payload information is information computed by the radio frequency identification device.

11. A system for securely communicating between a radio frequency identification device and a reader, said system comprises:
A) means for generating a light beam that carries power and information to the radio frequency identification device, and
B) identification device in response to the information carried by the light beam.

12. The system claimed in claim 11, further comprises means for requesting the identity of the radio frequency identification device, said requesting means transmits radio frequency signals from the reader to the radio frequency identification device.

13. The system claimed in claim 12, wherein the means for generating a light beam comprises:
A) a laser beam generator that transmits modulated information via a laser beam; and
B) a photocell and demodulator that is coupled to the laser beam, said photocell and demodulator supplies information and power to the radio frequency identification device.

14. The system claimed in claim 13, further comprising means for encrypting information carried by the laser beam.

15. The system claimed in claim 13, further comprising means for signing information carried by the laser beam.

16. The system claimed in claim 13, further comprising:
a digital signal processor that is coupled to said photocell and demodulator, said processor authenticates a request received from a base station.

17. The system claimed in claim 16, wherein said digital signal processor retrieve requested information.

16. The system claimed in claim 16, wherein said digital signal processor retrieve calculated information.
